(19) United States
(12) Patent Application Publication
(10) Pub. No.: US 2009/0150091 A1
(43) Pub. Date: Jun. 11, 2009

(54) CHROMATOGRAPHY DATA SYSTEM

(75) Inventors: Hirofumi TOSHIMA, Hitachinaka (JP); Kosaku TOYOSAKI, Ishioka (JP); Masato FUKUDA, Hitachinaka (JP); Kazuhiko OKUZAWA, Hitachinaka (JP); Masahito ITO, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION., Tokyo (JP)

(21) Appl. No.: 12/366,282

(22) Filed: Feb. 5, 2009

Related U.S. Application Data
(63) Continuation of application No. 11/498,751, filed on Aug. 4, 2006.

(30) Foreign Application Priority Data
Aug. 4, 2005 (JP) 2005-227129

(51) Int. Cl. G01N 30/86

(52) U.S. Cl. 702/32; 73/61.52

(57) ABSTRACT

There is provided a user interface which enables all users to input a purpose of use of a chromatography data system, recognize a series of operation flow of the analysis of chromatograph data according to the input purpose, improve an operability and prevent an operation error regardless of the user's knowledge on analyzing the chromatograph data or the user's proficiency in the chromatography data system. In a chromatograph data processing, the present invention relates to recognizing chromatograph data analyzing means on a picture and displaying the chromatograph data analyzing means on the picture in accordance with purpose of use. According to the present invention, the chromatography data system can be easily operated regardless of the knowledge on the analysis of chromatograph data or proficiency in the chromatography data system.

### RELATED APPLICATIONS

This application is a Continuation of U.S. application Ser. No. 11/498,751, filed Aug. 4, 2006, claiming priority of Japanese Application No. 2005-227129, filed Aug. 4, 2005, the entire contents of each of which are hereby incorporated by reference.

### BACKGROUND OF THE INVENTION

1. Field of the Invention

The present invention relates to a chromatography data system.

2. Description of the Related Art

Recently, a chromatography data system has highly advanced in functionality and a method of operating the same has been increasingly complicated. In particular, functions and operating targets in operating picture increase with the high advancement in functionality, thus the operating method furthers the complexity. In order to avoid these problems, in a known technique, functions which are frequently used are picked up and arrayed in operating menus or icons, or the operating menu of each function is hierarchized, so as to simplify the operation of each function.

[Patent Document 1] Japanese Patent Application Laid-Open No. 5-322870

A chromatography data system is generally divided into an analysis process and a recalculation process. Operations and operation flows are different in each process. For example, the analysis process includes setting analyzing methods such as a flow rate of a pump, preparing a sample table, stabilizing a baseline, analyzing a sample and the like. It is difficult for a person who does not possess the knowledge on the analysis of chromatogram to operate a series of operation flows. Further, the chromatograph data processing varies in purpose of use and a series of operation flows are also different in accordance with the purpose. Although the simplification of the operation in each function is furthered in the recent chromatography data system, it is difficult to visually understand a series of operation flows in the chromatograph data processing, whereby it is necessary to possess the knowledge on the chromatogram above a certain level in use.

Therefore, since a user who does not have the knowledge on the measurement of the chromatogram or who is not familiar with the operation cannot see a whole operation flow or know which part of an entire process is currently operated, the user may operate mistakenly or may not obtain his/her desired result.

### SUMMARY OF THE INVENTION

An object of the present invention is to provide a user interface which enables all users to input the purpose of use of the chromatography data system and recognize a series of operation flows of the analysis of chromatograph data in accordance with the input purpose of use regardless of the user's knowledge on the analysis of the chromatograph data or the user's proficiency in the chromatography data system so as to prevent operation errors by improving the operability.

The present invention relates to confirming a chromatograph data analyzing sequence on a picture, displaying the analyzing sequence in accordance with the purpose of use on the picture in a chromatography data system.

According to the present invention, a chromatography data system can be easily operated regardless of the knowledge on the analysis of chromatograph data or proficiency in the chromatography data system.

In the first embodiment, a chromatography data system includes an operating unit displaying operation menus and a calculating unit executing an operation commanded from the operating unit, wherein the chromatography data system further includes means which displays operating and setting items concerning the analysis of chromatograph data on the operating unit in a flowchart on the basis of a flow of the operation, means which displays status of the operation being currently performed on the flowchart, and means which changes a sequence of the flow, and the operating and setting items in the flowchart in accordance with the purpose of use.

In the chromatography data system, since the operating and setting items required for analyzing are displayed in a flowchart in accordance with a series of flows as the chromatograph data analyzing is begun, a whole work rate or an overall sequence becomes plain.

Further, since the working status being currently performed is displayed on the flowchart, the performed work and a remaining work rate become plain.

In addition, the operating and setting items, and the flow of the operation are different for each purpose of use. According to the present invention, since the sequence of the flow of the flowchart, and the operating and setting items can be changed in accordance with the purpose of use, it is possible to flexibly deal with analyzing the chromatograph data having a variety of purposes.

In the second embodiment, a chromatography data system includes an operating unit displaying operation menus and a calculating unit executing operation commanded from the operating unit, wherein the chromatography data system further includes storing means which stores operating and setting items in accordance with each purpose for analyzing chromatograph data, and display controlling means which displays the operating and setting items on the operating unit with reference to the operating and setting items corresponding to the operation in case that the purpose of use for analyzing the chromatograph data is designated.

The operating and setting items, and the flow of the operation are different for each purpose of use in analyzing the chromatograph data. Therefore, the flowchart related to the purpose of use is saved. Since the flowchart related to the purpose of use is displayed by designating the purpose, even if a user who does not possess the knowledge on chromatogram or a user who is not familiar with the operation performs analyzing the chromatograph data having a different purpose, the case that the user may operate mistakenly or may not obtain his/her desired result can be prevented and the user's proficiency in the analysis of the chromatograph data can be improved.

In the third embodiment, an outputting process outputs a picture for inquiring which process out of an analysis process and a recalculation process will be performed, and the inputting process answers which process out of the analysis process and the recalculation process will be performed.

The chromatography data system inquires which process out of the analysis process and the recalculation process is performed as analyzing the chromatograph data is begun, and the operator answers the inquiry. Thus, the chromatography data system recognizes which process is performed, and can correlate the input device or the output device to the process.

In the fourth embodiment, an output picture includes an output section which displays a series of operation flows concerning an analysis process, and an input section which receives a method setting in each process displaying part of the operation flow, each process of the operation flow being displayed in association with each other.

In the chromatography data system, since the operation flow related to the analysis process is displayed, a series of operation flows of the analysis process can be recognized. Further, since setting a method of each process can be performed on the operation flow and each process is related, the operator can perform the operation such as the method setting in accordance with the operation flow. Therefore, the analysis process can be easily operated, so that the operation error can be prevented.

In the fifth embodiment, the chromatography data system displays a method setting picture and/or a status displaying picture in case that the method setting is received from the input section of each process displaying part, in the fourth embodiment.

In the chromatography data system, since the method setting picture or/and the status display picture corresponding to the operation is/are displayed when the operation in each process is performed, the operator needs not to consider which setting item exists or which status is to be confirmed. Thus, the improvement of the operability can be attempted.

In the sixth embodiment, an output picture includes an output section which displays a series of operation flows concerning a recalculation process; and an input section which receives a method setting in each process displaying part of the operation flow, each process of the operation flow being displayed in association with each other.

In the chromatography data system, since the operation flow related to the recalculation process is displayed, a series of operation flows of the recalculation process can be recognized. Further, since setting a method of each process can be performed on the operation flow and each process is related, the operator performs the operation such as the method setting in accordance with the operation flow. Therefore, the analysis process can be easily operated, so that the operation error can be prevented.

In the seventh embodiment, the chromatography data system displays a method setting picture and/or a status displaying picture in case that the method setting is received from the input section of each process displaying part, in the sixth embodiment.

In the chromatography data system, since the method setting picture or/and the status display picture corresponding to the operation is/are displayed when the operation in each process is performed, the operator needs not to consider whether there is which setting item or which status is required to recognize what are the setting item. Thus, the improvement of the operability can be attempted.

Hereinafter, the above and other new characteristics and effects of the present invention will be described with reference to the drawings. However, components, types, composition, shape and relative disposition described in the embodiment do not limit a range of the invention but are nothing but simple descriptions assuming that there is no specific description.

### BRIEF DESCRIPTION OF THE DRAWINGS

FIG. 1 shows a configuration example of a standard chromatography system including a chromatography data system.

FIG. 2 shows a picture displayed firstly after starting a chromatography data system.

FIG. 3 show a picture displayed after pressing a analysis button 12 or a recalculation button 13 shown in FIG. 2.

FIG. 4 shows an example of an operation flow for a general analysis which performs analyzing one sample or consecutively analyzing two or more samples.

FIG. 5 shows an example of the status in which one analysis is currently performed.

### DESCRIPTION OF THE PREFERRED EMBODIMENTS

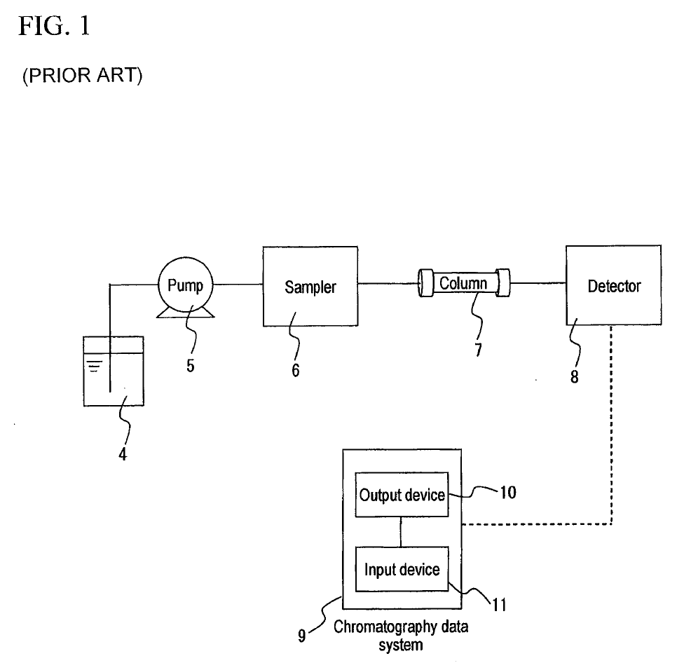

FIG. 1 shows a configuration example of a standard chromatography system including a chromatography data system in accordance with this embodiment. Eluent indicated by reference numeral 4 is sent by a pump 5, and flows into a sampler 6, a column 7 and a detector 8 sequentially. An analyzing sample is injected into a flow of the eluent 4 by the sampler 6 and separated into each component by the column. A spectrum of the separated sample is detected on a time axis by the detector 8 and the detection signal is transmitted to a chromatography data system 9. The chromatography data system 9 is constructed mainly by a computer system including a personal computer and the like.

The chromatography data system 9 has an output device 10 and an input device 11 as shown in FIG. 1. The input device 11, for example, receives operations such as instructing purpose of use and inputting a parameter by an operator by using a mouse or a keyboard. The output device 10 displays a picture concerning an instruction in accordance with the instruction from the input device 11 on, for example, a CRT (Cathode Ray Tube) or a liquid crystal display, and performs an activity such as, for example, actuating a pump.

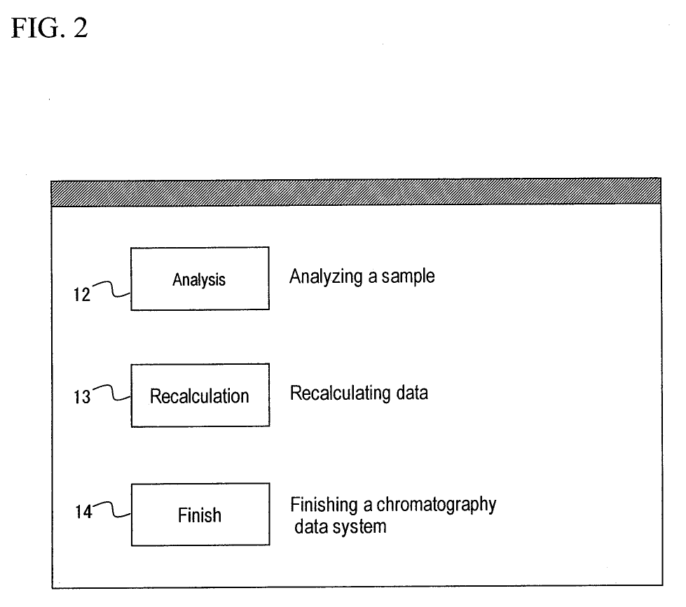

FIG. 2 shows a picture displayed firstly after starting a chromatography data system. As the chromatography data system is started, the picture is displayed on an output device and the operator is asked of whether a process to be performed is an analysis process or a recalculation process. The operator can select a predetermined process displayed on the picture out of the input candidates. The operator presses a analysis button 12 to perform the analysis process. The operator presses a recalculation button 13 to perform the recalculation process. The operator presses a finish button 14 to finish the chromatography data system.

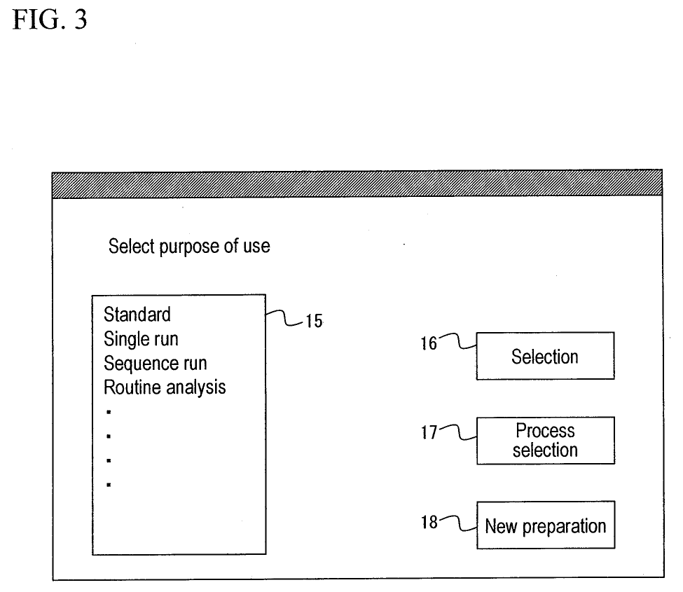

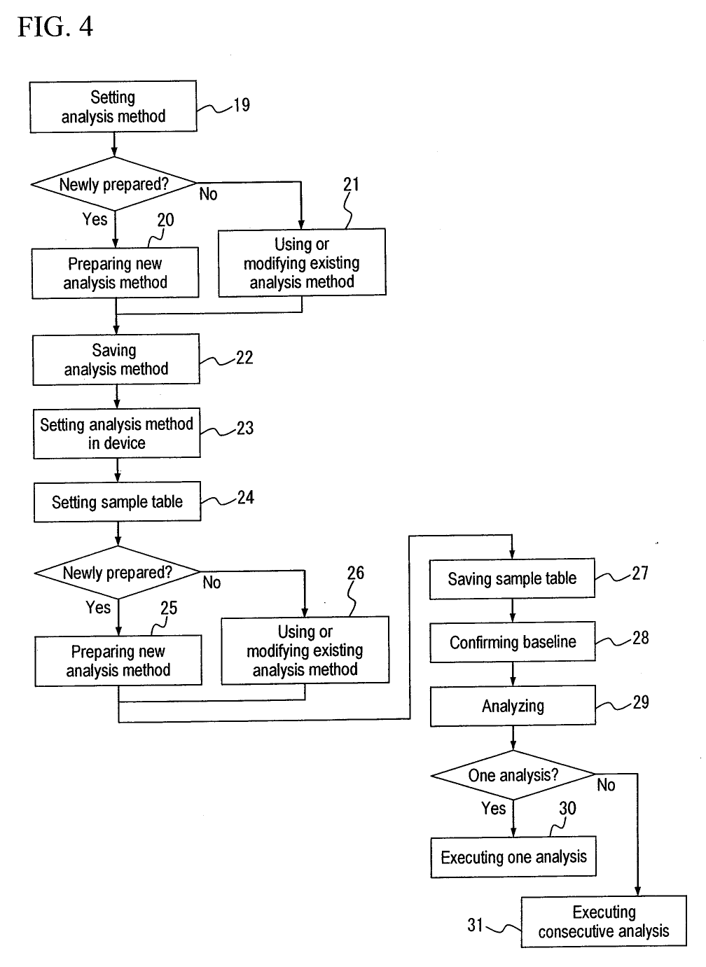

FIG. 3 shows a picture displayed after pressing the analysis button 12 or the recalculation button 13 shown in FIG. 2. Reference numeral 15 indicates a list of purpose of use. The purpose of use related to the process designated in FIG. 2 is displayed in the list shown in FIG. 3. For example, in case that the analysis button 12 is pressed, the list 15 of the purpose of use related to the analysis process is displayed. If the operator selects the purpose of use from the list 15 and presses a selection button 16, an operation flow picture corresponding to the object is displayed as shown in FIG. 4. The operator presses the selection button 17 to return to the picture of FIG. 2 and reselect a process. Further, if a new preparation button 18 is pressed, an operation flow picture corresponding to a new purpose of use and the object can be prepared. Here, prepared title of the purpose of use is added to the list 15. Then, if the added purpose of use is selected and the selection button 16 is pressed, the operation flow picture prepared in the new preparation is displayed in FIG. 4.

FIG. 4 shows an example of an operation flow for a general analysis which performs analyzing one sample or consecutively analyzing two or more samples. Setting 19 an analysis method such as, for example, setting a flow rate of the pump 5 is performed to analyze a sample. Next, saving 22 the analysis method is performed and setting 23 the analysis method such as setting the flow rate or a wavelength in the pump 5 or the detector 8 is performed. Then, setting 24 the sample table such as setting a name of a analyzed sample or the analysis method for analyzing an input sample is performed, and saving 27 the prepared sample table is performed. Next, confirming 28 a baseline is performed for stabilizing the baseline. Finally, executing 30 one analysis for analyzing one sample or executing 31 a consecutive analysis for analyzing two or more samples is performed.

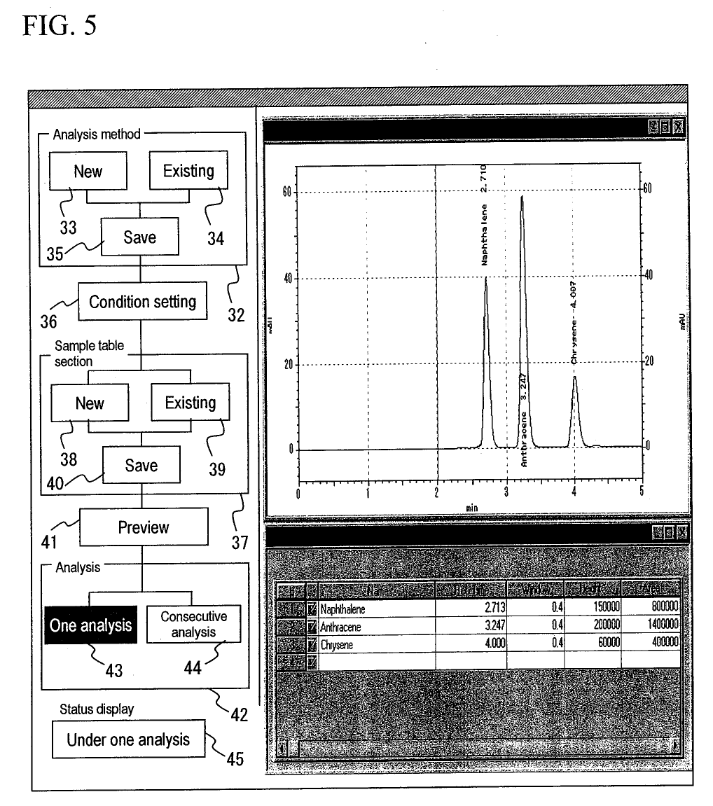

In case that an object of performing works shown in FIG. 4 is selected in FIG. 3, the operation flow is displayed on the picture as shown in FIG. 5 in accordance with the flow of FIG. 4.

Setting 19 the analysis method corresponds to a section 32 of the analysis method, and preparing 20 a new analysis method corresponds to a new button 33. Using or modifying 21 the existing analysis method corresponds to the existing button 34. If the new button 33 is clicked, a method setting picture for newly preparing the analysis method is displayed and if the existing button 34 is clicked, a picture for selecting the existing analysis method is displayed.

Saving 22 the analysis method corresponds to a saving button 35. If the saving button 35 is clicked, a picture for saving the analysis method is displayed.

Setting 23 a device condition in a device corresponds to a condition setting button 36. If the condition setting button 36 is clicked, the analysis method is set in the device.

Setting 24 the sample table corresponds to a sample table section 37, and preparing 25 a new analysis method corresponds to a new button 38. Using or modifying 26 the existing analysis method corresponds to the existing button 39. If the new button 38 is clicked, a sample table setting picture for newly preparing the sample table is displayed and if the existing button 39 is clicked, a picture for selecting the existing sample table is displayed.

Saving 27 the sample table corresponds to a saving button 40. If the saving button 40 is clicked, a picture for saving the sample table is displayed.

Confirming 28 the baseline corresponds to a preview button 41. If the preview button 41 is clicked, a chromatogram picture for confirming the baseline is displayed.

Analyzing 29 corresponds to an analysis section 42. Executing 30 one analysis corresponds to one analysis button 43 and executing 31 a consecutive analysis corresponds to a consecutive analysis button 44. If one analysis button 43 is clicked, analyzing one sample is executed and if the consecutive analysis button 44 is clicked, analyzing two or more samples are executed.

Further, the status of the operation being currently performed is displayed in a status display 45 and a color of a button being currently operated is reversed. FIG. 5 shows an example of the status in which one analysis is currently performed. The one analysis currently being performed is displayed in the status display 45, and the color of one analysis button being currently operated is reversed.

As described above, in case that the analysis process or the recalculation process which is a working process is designated in the chromatography data system having the input device and the output device of this embodiment, selection candidates of the purpose of use corresponding to the work are displayed, and when any one of the displayed selection candidates is selected, since an operation performed for the corresponding object and an operation flow showing the flow of the operation are automatically displayed, the operator can grasp a overall working content just by selecting the working process and the purpose of use and can achieve the purpose by performing the operation in accordance with the operation flow. Therefore, the operability can be improved. In addition, since any operation except the operation performed for the purpose is not displayed, a misoperation can be prevented.

Further, in the chromatography data system having the input device and the output device of this embodiment, since the selection candidates of the purpose of use can be freely prepared and the operation flow of the purpose of use can be freely prepared, it is possible to flexibly deal with the chromatograph data analyzing having a variety of purposes.

1-7. (canceled)

8. A method for operating a chromatography data system, the method comprising the steps of:
presenting a list of purposes of use for selection, wherein the list includes a plurality of purposes of use comprising: standard, single run, sequence run, and routine analysis; and
presenting an option to create a new purpose of use for addition to the list.

9. The method of claim 8, wherein the option to create the new purpose of use for addition to the list comprises the steps of:
presenting a general analysis flow chart for creating a new purpose of use for addition to the list.

10. The method of claim 9, wherein the general analysis flow chart comprises at least three portions:
a setting analysis portion;
a sample table portion; and
an analyzing portion.

11. The method of claim 8, further comprising the steps of:
selecting a purpose of use from the presented list;
displaying a purpose of use flow chart corresponding to the selected purpose of use; and
graphically indicating a status of operating the chromatography data system.

12. The method of claim 11, wherein the status is graphically indicated by highlighting or changing the appearance of a block in the displayed flow chart, wherein the block corresponds to a chromatography step presently being performed.

13. The method of claim 11, wherein the status is graphically indicated via a dedicated status display window, wherein the status corresponds to a chromatography step presently being performed.

14. A chromatography data system for performing chromatography, wherein the system is configured to perform the steps of:
presenting a list of purposes of use for selection, wherein the list includes a plurality of purposes of use comprising: standard, single run, sequence run, and routine analysis; and
presenting an option to create a new purpose of use for addition to the list.

15. The chromatography data system of claim 14, wherein the option to create the new purpose of use for addition to the list comprises the steps of:
presenting a general analysis flow chart to the user for creating a new purpose of use for addition to the list.

16. The chromatography data system of claim 15, wherein the general analysis flow chart comprises at least three portions:
a setting analysis portion;
a sample table portion; and
an analyzing portion.

17. The chromatography data system of claim 14, further comprising the steps of:
selecting a purpose of use from the presented list;
displaying a purpose of use flow chart corresponding to the selected purpose of use; and
graphically indicating a status of operating the chromatography data system.

18. The chromatography data system of claim 17, wherein the status is graphically indicated by highlighting or changing the appearance of a block in the displayed flow chart, wherein the block corresponds to a chromatography step presently being performed.

19. The chromatography data system of claim 17, wherein the status is graphically indicated via a dedicated status display window, wherein the status corresponds to a chromatography step presently being performed.
